(19) United States
(12) Patent Application Publication
(10) Pub. No.: US 2009/0009016 A1
(43) Pub. Date: Jan. 8, 2009

(54) Spindle Motor

(76) Inventor: Yong Tae Kim, Ansan-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/168,536

(22) Filed: Jul. 7, 2008

(30) Foreign Application Priority Data
Jul. 7, 2007 (KR) 10-2007-0068384

(51) Int. Cl. H02K 5/16

(52) U.S. Cl. 310/90

(57) ABSTRACT

A spindle motor is provided. The spindle motor comprises a base, a bearing housing, a bearing, a rotatable rotating shaft, a stator, and a rotor. The base comprises a coupling area protruding therefrom. The bearing housing is fixed to the coupling area. The bearing is disposed within the bearing housing. The rotatable rotating shaft has one side and the other side. The one side is fixed to the bearing, and the other side is exposed toward an outside of the bearing housing. The stator is disposed around the bearing housing. The rotor is fixed to the rotating shaft to rotate by interaction with the stator.

### CROSS-REFERENCE TO RELATED APPLICATIONS

The present application claims priority under 35 U.S.C. 119(e) of Korean Patent Application No. 10-2007-0068384, filed on Jul. 7, 2007, which is hereby incorporated by reference in its entirety.

### BACKGROUND

The present disclosure relates to a spindle motor.

A spindle motor can be applied to various electronic devices. Typically, the spindle motor rotates an optical disk in order to record data onto the optical disk or read the data recorded onto the optical disk.

### BRIEF SUMMARY

Embodiments provide a spindle motor having a new structure.

Embodiments also provide a spindle motor capable of preventing a rotor and a rotating shaft from being floated.

Embodiments also provide a spindle motor capable of preventing oil from being leaked from a bearing to the outside of a bearing housing.

In one embodiment, a spindle motor comprises: a base comprising a coupling area protruding therefrom; a bearing housing fixed to the coupling area; a bearing within the bearing housing; a rotatable rotating shaft having one side and the other side, the one side being fixed to the bearing and the other side being exposed toward an outside of the bearing housing; a stator around the bearing housing; and a rotor fixed to the rotating shaft to rotate by interaction with the stator.

The details of one or more embodiments are set forth in the accompanying drawings and the description below. Other features will be apparent from the description and drawings, and from the claims.

### BRIEF DESCRIPTION OF THE DRAWINGS

FIG. 1 is a cross-sectional view of a spindle motor according to an embodiment.

FIG. 2 is a partial enlarged view illustrating a portion “A” of FIG. 1.

### DETAILED DESCRIPTION

Hereinafter, a spindle motor according to embodiments will be described in detail with reference to the accompanying drawings.

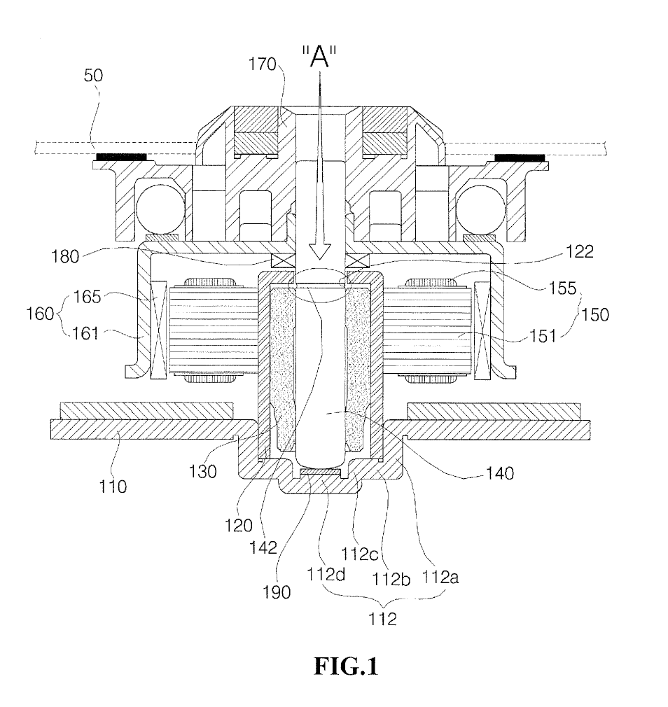

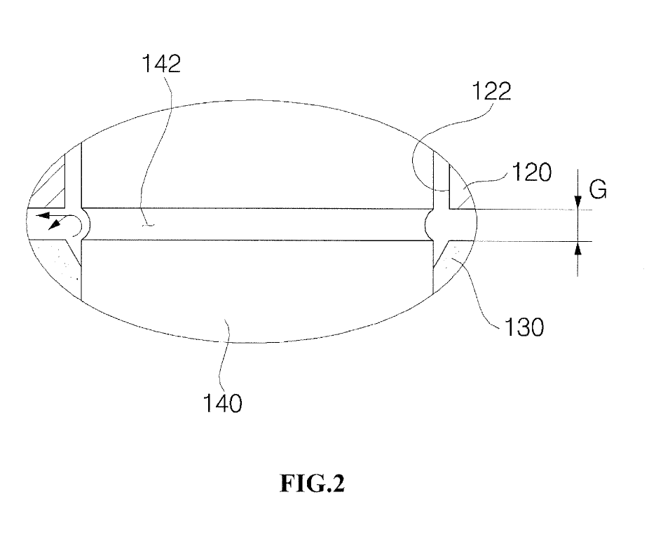

FIG. 1 is a cross-sectional view of a spindle motor according to an embodiment, and FIG. 2 is a partial enlarged view illustrating a portion “A” of FIG. 1.

Referring to FIGS. 1 and 2, a base 110 is prepared. The base 110 is manufactured using a drawing process. A coupling area 112 protrudes from the base 110. The coupling area 112 includes a first vertical portion 112a, a flange portion 112b, a second vertical portion 112c, and a sealing portion 112d. The first vertical portion 112a has a pipe shape and vertically extends in one direction of the base 110. The flange portion 112b has a ring shape. Also, the flange portion is bent inwardly at an end portion of the first vertical portion 112a and approximately parallel to the base 110. The second vertical portion 112c vertically extends in one direction of the base 110 from an inner peripheral surface of the flange portion 112b. The sealing portion 112d seals an end portion of the second vertical portion 112c.

Hereinafter, a “lower side” and a “lower surface” denote a downward direction and a surface orientated toward a downward direction of the base 110 with respect to the base 110, respectively. Similarly, an “upper side” and an “upper surface” denote an upward direction and a surface orientated upward an upward direction of the base 110 with respect to the base 110.

If a height of the upper surface of the base 110 is defined as a first height, the flange portion 112b is disposed at a second height less than the first height, and the sealing portion 112d is disposed at a third height less than the second height.

An outer peripheral surface of a lower portion of a bearing housing 120 having a cylindrical shape is press-fitted into the coupling area 112. A lower surface of the bearing housing 120 is opened, and a bending portion bent toward a rotating shaft 140 described below is disposed at an upper surface of the bearing housing 120. A through hole 122 is defined in the upper surface of the bearing housing 120. The outer peripheral surface of the lower portion of the bearing housing 120 is press-fitted into an inner peripheral surface of the first vertical portion 112a. A lower end surface of the bearing housing 120 is supported by and in contact with the flange portion 112b.

The bearing housing 120 is manufactured using the drawing process, but may be manufactured through an injection process.

The bearing 130 immersed in oil is press-fitted into an inner surface of the bearing housing 120. A lower portion of the rotating shaft 140 is rotatably supported to the bearing 130. An upper portion of the rotating shaft 140 passes through the through hole 122 to protrude toward an upper side of the bearing housing 120.

In the spindle motor according to this embodiment, since the coupling area 112 is manufactured while the base 110 is manufactured using the drawing process, the coupling area 112 is accurately perpendicular to the base 110. Thus, since the bearing housing 120 press-fitted into the coupling area 112 is also perpendicular to the base 110, the rotating shaft 140 supported by the bearing 130 coupled to the bearing housing 120 is also perpendicular to the base 110. Therefore, vibration and noise due to the inclined rotating shaft 140 does not occur to improve reliability of products.

A stator 150 is fixed to an outer surface of the bearing housing 120, and a rotor 160 is fixed to the rotating shaft 140 of an upper side of the bearing housing 120.

The stator 150 includes a core 151 and a coil 155. The core 151 is press-fitted into the outer surface of the bearing housing 120. The coil is wound around the core 151. The rotor includes a rotor yoke 161 and a magnet 165. The rotor yoke 161 has a cylindrical shape in which a bottom surface thereof is opened and is fixed to the rotating shaft 140. The magnet 165 is coupled to an inner surface of the rotor yoke 161 and faces the stator 150.

When a current is applied to the coil 155, the rotor 160 rotates due to an electromagnetic force generated between the coil 155 and the magnet 165 so that the rotating shaft 140 also rotates.

A turntable 170 on which a disk 50 is mounted and supported is fixed to the rotating shaft 140 of an upper side of the rotor yoke 161 to rotate with the rotating shaft 140 together. The disk 50 may be mounted on the rotor yoke 161 instead of the turntable 170.

When the rotating shaft 140 rotates, the oil flows out of the bearing 130 due to a load transferred to the bearing 130 from the rotating shaft 140 by a centrifugal force. The oil flowing out of the bearing 130 rises toward an upper side of the bearing 130 along an interface between the bearing 130 and the rotating shaft 140. Thereafter, the oil is leaked outside the bearing housing 120 due to the centrifugal force.

In the spindle motor according to this embodiment, since the upper side of the bearing 130 is covered with the upper surface of the bearing housing 120, the oil rising toward the upper side of the bearing 130 is not leaked outside the bearing housing 120. However, the oil continuously rises through a gap between the through hole 122 and the rotating shaft 140.

In the spindle motor according to this embodiment, in order to prevent the oil flowing out of the bearing 130 from rising toward the upper side of the bearing 130, provide is a predetermined gap G between the upper surface of the bearing housing and an upper surface of the bearing 130. A depressed passage 142 having a ring shape is disposed in the outer peripheral surface of the rotating shaft 140 corresponding to the gap G. Thus, the oil rising toward the upper side of the bearing 130 does not continuously rise, but is stored in the depressed passage 142. Thereafter, the stored oil drops due to a self-weight and the centrifugal force to again flow into the bearing 130.

When the rotating shaft 140 rotates, the rotating shaft 140 and the rotor 160 are intended to float themselves. In order to prevent the rotating shaft 140 and the rotor 160 from being floated, an attraction magnet 180 is disposed on the bottom surface of the rotor yoke 161 corresponding to the upper surface of the bearing housing 120. That is, since the attraction magnet 180 is intended to be attached to the bearing 120 disposed under the attraction magnet 180, it can prevent the rotor 160 and the rotating shaft 140 from being levitated.

In the spindle motor according to this embodiment, since the upper surface of the bearing housing 120 exists, an external diameter of the attraction magnet 180 can be less than that of the bearing housing 120. That is, since the attraction magnet 180 can have a dimension smaller than the dimension the upper surface of the bearing housing 120, the attraction magnet 180 having a relatively small size can be adopted.

A thrust plate 190 is disposed on the sealing portion 112d of the coupling area 112. A lower end surface of the rotating shaft 140 is in contact with and supported by the thrust plate 190.

As described above, in the spindle motor according to the present disclosure, since the coupling area 112 of the base 110 coupled to the bearing housing 120 is manufactured while the base 110 is manufactured, the coupling area 112 maintains a right angle with respect to the base 110. Thus, when the bearing housing 120 to which the bearing 130 and the rotating shaft 140 are coupled is coupled to the coupling area 112, the bearing housing 120 and the rotating shaft 140 are perpendicular to the base 110. Accordingly, the vibration and noise due to the inclined rotating shaft 140 does not occur. Therefore, the reliability of products can be improved.

In addition, since the oil flowing out of the bearing 130 is not leaked outside the bearing housing 120 due to the upper surface of the bearing housing 120 and the depressed passage 142 of the rotating shaft 140, it is not necessary for an auxiliary component for preventing the oil flowing out of the bearing 130 from being leaked outside the bearing housing 120. Therefore, manufacturing costs can be reduced.

In addition, since the upper surface of the bearing housing 120 exists, the external diameter of the attraction magnet 180 corresponding to the upper surface of the bearing housing 120 can be less than that of the bearing housing 120. That is, the attraction magnet 180 having the relatively small size can be used to further reduce the manufacturing costs.

It will be apparent to those skilled in the art that various modifications and variations can be made in the present invention. Thus, it is intended that the present invention covers the modifications and variations of this invention provided they come within the scope of the appended claims and their equivalents.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangments of the subject combination arrangement within the scope of the disclosure, the drawings and the appended claims. In addition to variations and modifications in the component parts and/or arrangements, alternative uses will also be apparent to those skilled in the art.

What is claimed is:

1. A spindle motor comprising:
a base comprising a coupling area protruding therefrom;
a bearing housing fixed to the coupling area;
a bearing within the bearing housing;
a rotatable rotating shaft having one side and the other side, the one side being supported by the bearing and the other side being exposed toward an outside of the bearing housing;
a stator around the bearing housing; and
a rotor fixed to the rotating shaft to rotate by interaction with the stator.

2. The spindle motor according to claim 1, wherein the bearing housing comprises a bending portion bent in a rotating shaft direction and a through hole through which the rotating shaft passes at an upper side thereof.

3. The spindle motor according to claim 2, where a gap is defined between a lower surface of the bending portion and the bearing.

4. The spindle motor according to claim 2, wherein the rotating shaft comprises a depressed passage between the bending portion and the bearing.

5. The spindle motor according to claim 4, wherein the depressed passage has a ring shape.

6. The spindle motor according to claim 1, wherein the coupling area comprises a first vertical portion having a pipe shape and extending downwardly in a vertical direction of the base, a flange portion having a ring shape and bent inwardly at an end portion of the first vertical portion, a second vertical portion extending downwardly in a vertical direction of the base from an inner peripheral surface of the flange portion, and a sealing portion sealing an end portion of the second vertical portion.

7. The spindle motor according to claim 6, wherein an outer peripheral surface of a lower side of the bearing housing is insertedly coupled to the first vertical portion.

8. The spindle motor according to claim 6, wherein a lower end is in contact with the flange portion.

9. The spindle motor according to claim 6, wherein the sealing portion comprises a thrust plate in contact with a lower end of the rotating shaft.

10. The spindle motor according to claim 6, further comprising an attraction magnet having a dimension smaller than that of the bending portion, wherein the attraction magnet is fixed to the rotor to face the bending portion.

11. The spindle motor according to claim 1, wherein the base and the bearing housing are integrated through a drawing process.

12. The spindle motor according to claim 1, wherein the bearing housing is press-fitted into the coupling area.
